(19) United States
(12) Patent Application Publication
(10) Pub. No.: US 2026/0175411 A1
(43) Pub. Date: Jun. 25, 2026

(54) ACTUATOR APPARATUS

(71) Applicant: IUVO S.R.L, Pontedera (PI) (IT)

(72) Inventors: Lorenzo SACCARES, Pontedera (PI) (IT); Matteo MOISE, Pontedera (PI) (IT); Giacomo GIUSFREDI, Pontedera (PI) (IT); Marco MUSCOLO, Pontedera (PI) (IT); Francesco GIOVACCHINI, Pontedera (PI) (IT)

(21) Appl. No.: 19/125,843

(22) PCT Filed: Nov. 2, 2023
(86) PCT No.: PCT/IB2023/061070

§ 371 Date: Apr. 30, 2025

Related U.S. Application Data
(60) Provisional application No. 63/421,862, filed on Nov. 2, 2022.

(51) Int. Cl. B25J 9/12; B25J 9/00; B25J 9/10

(52) U.S. Cl. CPC B25J 9/126; B25J 9/0006; B25J 9/1025

(57) ABSTRACT

An actuation unit is designed as a series elastic actuator having a brushless motor which transmits rotation and torque at the output shaft of the actuation apparatus through a gearbox. One or more torsional springs connect the motor and the gearbox to the actuation apparatus frame. The reaction torques generated by the gearbox and the motor induce a deformation of the torsional spring. The deformation is then read by a rotary encoder module that allows for computing the torque generated by the actuation apparatus.

### CROSS-REFERENCE TO RELATED DISCLOSURES

This application incorporates by reference: International application No. PCT/IB2014/062735, filed on Jun. 30, 2014, and published as WO 2015/001469 A1 on Jan. 8, 2015; International application No. PCT/IB2016/050639, filed on Feb. 8, 2016, and published as WO 2016/128877 A1 on Aug. 18, 2016; International application No. PCT/IB2019/053598, filed on May 2, 2019, and published as WO 2019/211791 A1 on Nov. 7, 2019; International application No. PCT/US2020/029573, filed on Apr. 23, 2020, and published as WO 2020/219712 A1 on Oct. 29, 2020; and International application No. PCT/IB2021/058139, filed on Sep. 7, 2021, and published as WO 2022/053934 A1 on Mar. 17, 2022.

This application also incorporates by reference a U.S. Provisional Application No. 63/421,862, filed on Nov. 2, 2022, entitled ACTIVE PELVIC ORTHOSIS INCLUDING A PHYSICAL HUMAN-ROBOT INTERFACE. Likewise, the application incorporates by reference a PCT Application entitled ACTIVE PELVIC ORTHOSIS INCLUDING A PHYSICAL HUMAN-ROBOT INTERFACE, filed on Nov. 2, 2023 by the same applicant and assignee of this disclosure.

### FIELD OF THE DISCLOSURE

The disclosure relates to an actuation system for wearable robotics, in particular for an active pelvis orthosis bearing a hip joint.

### BACKGROUND

Motor disorders associated with aging present challenges for individuals that require mobility assistance, especially in walking and activities of daily living. Robotic orthoses and exoskeletons provide a promising solution to assist elderly people and other individuals living with motor deficits. These orthoses usually have an anthropomorphic form and are worn by the subject. For active assistance purposes, such a robotic orthosis can include an actuation mechanism which generates mechanical power and transfers that power to the affected joint segment.

An example of a robotic orthosis is an active pelvis orthosis (APO), which is a wearable orthosis arranged to improve gait energy efficiency especially as affected by impairments of the hip. The APO may be of the type described in WO 2016/128877, which employs a sophisticated system of links, actuator, and other components to allow the human flexion-extension axis to align with the control systems to give the user hip abduction-adduction rotation, and internal-external rotation assistance.

Known actuation mechanisms used in robotic orthoses include electric actuators, pneumatic actuators, hydraulic actuators, and passive actuators. Notably, the scientific community has taken advantage of Series Elastic Actuators (SEAs) for use in various applications. SEAs are actuators that feature a passive elastic element in series with a motor and gearbox, wherein the elastic element is placed between the gearbox and a load.

The basic design of a SEA can be observed in FIGS. 1A-B of the present application, which will be described in greater detail below. In a general static condition, the torque (Δτ) exchanged between the SEA and the load can be estimated multiplying the deformation (Δθ) of the torsional spring by the stiffness (K) of the spring, resulting in the following equation:

$$Δ τ = k \times Δ θ$$

If the SEA generates an output torque (i.e., an action) (Δτ), the load produces a reaction equal in magnitude to the action, but opposite in direction. Such an output torque (Δτ) does not generate a motion of the SEA or the load; rather, the output torque (Δτ) induces a torsional deformation on the spring (Δθ) based on following formula:

$$Δτ / k = Δ θ = Δ {θ}_{1} - Δ {θ}_{2}$$

If the value of the output torque (Δτ) cannot be directly measured, the value can be estimated when the stiffness (K) of the spring is known and the deformation values (Δθ₁, Δθ₂) are measured by an encoder module.

The elastic element of a SEA generates a compliant mechanical interface between the motor and the load. The elasticity generally provides reduced reflected inertia and increased shock absorption and energy storage capabilities. However, one of the criticalities when it comes to implementing this type of actuator lies in the choice and construction of the elastic element. Disadvantages of using a traditional SEA include a reduction of the positioning bandwidth and an increase in the number of mechanical parts with a consequent overall weight increase. The SEA-load interaction of traditional SEAs cannot be directly measured; rather, it can be estimated indirectly if the stiffness of the elastic element is known and if the elastic deformation of the spring can be measured. Accordingly, there is a need for an improved actuation unit.

Regarding the elastic element of a SEA, it is desirable for the elastic component to have a low manufacturing cost and a reduced weight and encumbrance, especially when it is to be integrated with wearable robotic technology. Additionally, as the elastic element should be designed based on fatigue criteria, the SEA should be able to perform accurate force tracking and torque control of the system, which requires the stiffness of the elastic element to be within a range of specified values. Finally, the design of an elastic element and SEA should enable an assembly procedure that is univocally defined and repeatable. Thus, an objective of the actuator apparatus described in the present application is to provide an improved SEA having an elastic component with these desired characteristics.

The subject matter claimed herein is not limited to embodiments that solve any disadvantages or that operate only in environments such as those described above. Rather, this background is only provided to illustrate examples in one technology where some embodiments of the actuation apparatus described herein may be utilized.

### SUMMARY

Embodiments of the disclosed device, system, and method relate to an actuator apparatus or actuation unit having an improved series elastic actuator (SEA). The present disclosure is directed to an actuation apparatus device, or actuation system, and method for generating assistive torque for an active pelvis orthosis (APO) user. An object of the present disclosure is to provide an improvement over the prior art solution discussed above, in particular from the standpoints of ergonomics and convenience of use, such as weight reduction, compactness, and customized elastic elements acting together as a torsional spring to connect the motor and the gearbox to the actuation apparatus frame.

The actuator apparatus is a highly customized, rotative, electric SEA. The actuator apparatus has a brushless motor which transmits rotation and torque at the output shaft of the actuation apparatus through a gearbox. One or more torsional springs, or elastic elements, connect the motor and the gearbox to the actuation unit frame. The reaction torques generated by the gearbox and the motors induce a deformation of the torsional springs. The deformation is then read by a rotary encoder module that allows for computing the torque generated by the actuation unit.

The one or more torsional springs provide a compact torsional elastic assembly, provided with a linear angle/torque characteristic which is also not affected by the direction of rotation. The one or more torsional springs avoid unwanted contact between parts, have the high capacity of interfacing with the elements to which it should be connected, and are capable of attaining a high transmissible torque relative to its weight and overall dimension. The design of the one or more torsional springs are based on fatigue criteria. The torsional spring is not arranged between the gearbox and load, as observed in prior art devices, but rather on an opposing end of the load. This feature is maintained also in the following designs of the elastic element that will be described in the next sections.

Incorporating more than one torsional spring may allow for cost reduction in the manufacturing of the actuation apparatus. The orientation of fastening means between torsional springs may be oriented along axial or radial dimensions of the torque output axis of the actuation apparatus.

Additionally, the fastening means oriented along the radial dimension of the actuation apparatus allows for interrupting a chain of axial relative placement of different components. Indeed, the sequence of mating parts, each one with its dimensional tolerance, presents a clearance given by apertures designed in the torsional springs for accepting the screws that connect the springs. Therefore, only the necessary elements of the sequence or chain of mating parts drive the final axial relative placement of components during their assembly procedure.

These and other aspects of the disclosed actuation apparatus, as well as the methods of operation and functions of the related elements of structure and the combination of parts, will become more apparent upon consideration of the following description and the appended claims with reference to the accompanying figures, all of which form a part of this specification.

For purposes of summarizing the disclosed actuation apparatus, certain aspects, advantages, and novel features of the actuation apparatus have been described herein. It is to be understood that not necessarily all such advantages may be achieved in accordance with any particular embodiment of the actuation apparatus. Thus, the actuation apparatus may be embodied or carried out in a manner that achieves or optimizes one advantage or group of advantages as taught herein without necessarily achieving other advantages as may be taught or suggested herein.

### Glossary

The term “approximately” means a value within a statistically significant range of value or values, such as the stated length, distance, weight, height, angle, or force.

The term “encoder” is understood to have its ordinary and usual meaning to one skilled in the art, and, unless specified, may refer to absolute and incremental encoders. The encoder may encompass a device or sensor used to detect position. The encoder may be mechanical, optical, magnetic, or electromagnetic induction type.

The term “elastic” means being capable of recovering in size and shape after deformation.

The term “gearbox,” or “gear train,” has its ordinary meaning and refers to a series of gears designed to achieve a particular overall gear ratio. The gearbox disclosed in the present application is based on a harmonic drive and acts as a speed reducer and torque amplifier.

As used, the terms “rigid,” “flexible,” “compliant,” and “resilient” may distinguish characteristics of portions of certain features of the actuation system. The term “rigid” should denote that an element of the actuation system, such as a frame, is generally devoid of flexibility. Within the context of features that are “rigid,” it should indicate that they do not lose their overall shape when force is applied and may break if bent with sufficient force. The term “flexible” should denote that features are capable of repeated bending such that the features may be bent into non-retained shapes, or the features do not retain a general shape, but continuously deform when force is applied. The term “resilient” may qualify such flexible features as generally returning to an initial general shape without permanent deformation. As for the term “semi-rigid,” this term may connote properties of support members or shells that provide support and are free-standing; however, such support members or shells may have flexibility or resiliency.

The terms “substantial” or “substantially” mean that the recited characteristic, parameter, or value need not be achieved exactly, but that deviations or variations, including for example, tolerances, measurement error, measurement accuracy limitations and other factors known to those of skill in the art, may occur in amounts that do not preclude the effect the characteristic was intended to provide. The terms “substantial” or “substantially” mean ±10% in some embodiments, ±5% in some embodiments, and ±1% in some embodiments.

The term “user” refers to a person who uses the active pelvis orthosis. The user may be a patient or an operator.

It will be understood that, unless a term is defined to possess a described meaning, there is no intent to limit the meaning of such term, either expressly or indirectly, beyond its plain or ordinary meaning.

### BRIEF DESCRIPTION OF THE DRAWINGS

References will be made to embodiments of the disclosure, examples of which may be illustrated in the accompanying figures. These figures are intended to be illustrative, not limiting. Although the disclosure is generally described in the context of these embodiments, it should be understood that it is not intended to limit the scope of the disclosure to these particular embodiments. Items in the figures are not necessarily drawn to scale.

Further characteristics and advantages of the invention will emerge clearly from the ensuing description referring to the annexed drawings, which are provided purely by way of non-limiting example and in which:

FIG. 1A illustrates a block diagram of a traditional Series Elastic Actuator.

FIG. 1B illustrates a cross-sectional view of a traditional Series Elastic Actuator.

FIG. 2 is a perspective view illustrating an exemplary wearable robot device arranged as Active Pelvis Orthosis.

FIGS. 3A-3C illustrate cross-sectional views of the assistive unit of the Active Pelvis Orthosis of FIG. 2.

FIG. 3D illustrates a cross-sectional view the Active Pelvis Orthosis of FIG. 2 comprising a transmission unit having a crank-rod system.

FIG. 4 illustrates a cross-section of an embodiment of an actuation apparatus according to the disclosure.

FIG. 5A illustrates a block diagram of an embodiment of the disclosed actuation apparatus having an elastic element at the beginning of the chain.

FIGS. 5B-5C illustrate perspective and cross-sectional views of the actuation apparatus relating to FIG. 5A.

FIGS. 6A-6C illustrate perspective and cross-sectional views of the actuation apparatus relating to FIG. 5A having an elastic element directly connected to a frontal frame of a Series Elastic Actuator.

FIG. 7A illustrates a block diagram of an embodiment of the disclosed actuation apparatus having multiple elastic elements in series at the beginning of the chain.

FIGS. 7B-7C illustrate perspective and cross-sectional view of the actuation apparatus relating to FIG. 7A having an axial connection between at least one elastic element and the rotative actuator.

FIGS. 8A-8C illustrate perspective and cross-sectional views of the actuation apparatus relating to FIG. 7A having a radial connection between at least one elastic element and the rotative actuator.

FIG. 9A illustrates a block diagram of an embodiment of the disclosed actuation apparatus having multiple elastic elements in series and parallel at the beginning of the chain.

FIG. 9B-9D illustrate perspective and cross-sectional views of the actuation apparatus relating to FIG. 9A having reduced dimensional tolerances of components.

FIGS. 10A-10B illustrates perspective and cross-sectional views of the actuation apparatus relating to FIG. 9A having reduced axial dimensions for at least one elastic element.

FIGS. 11A-11B illustrate cross-sectional views of a variation of the assistive unit of the Active Pelvis Orthosis of FIG. 2.

FIG. 12A illustrates a cross-sectional view of the assistive unit of FIG. 11A.

FIG. 12B illustrates a cross-sectional view of the assistive unit of FIG. 10A.

FIGS. 13A-13B illustrate cross-sectional views of another variation of the assistive unit of the Active Pelvis Orthosis of FIG. 2.

FIG. 14 illustrates a block diagram of another embodiment of an actuation apparatus.

### DETAILED DESCRIPTION OF VARIOUS EMBODIMENTS

A better understanding of different embodiments of the disclosure may be had from the following description read in conjunction with the accompanying drawings in which like reference characters refer to like elements.

### A. Theoretical Background

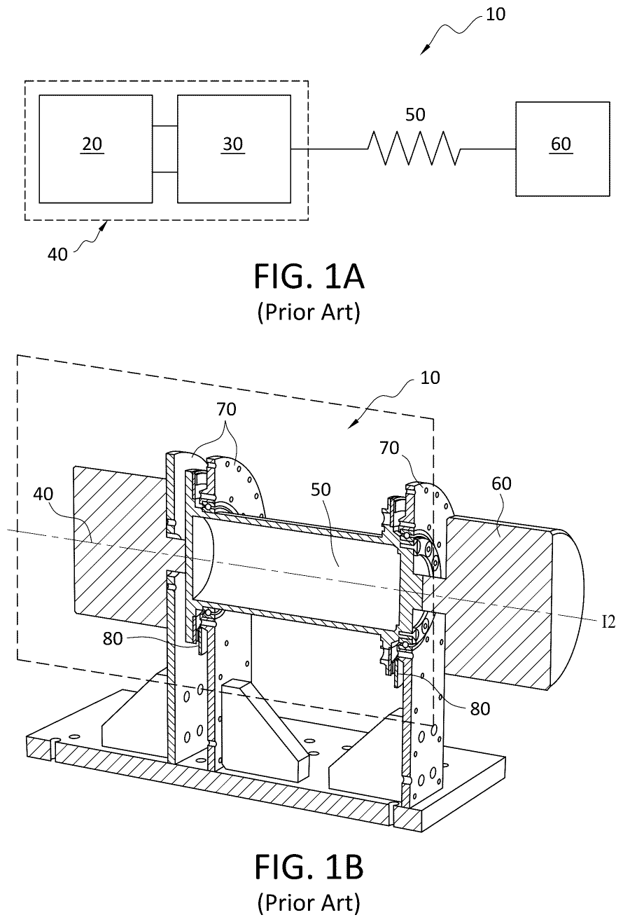

FIGS. 1A-1B depict designs for a traditional Series Elastic Actuator (SEA) system 10. FIG. 1A shows a rotative actuator 40 comprising a motor 20 and a gearbox 30. The elastic element 50 is in series with the motor 20 and gearbox 30 and it placed between the rotative actuator 40 and the load 60.

FIG. 1B illustrates a cross-sectional view of the SEA system 10 in FIG. 1A support for two frame components 70. In a general static condition, the torque (Δτ) exchanged between the SEA system 10 and the load 60 can be estimated multiplying the deformation (Δθ) of the elastic element 50 by the stiffness (K) of the elastic element 50, resulting in the following equation:

$$Δ τ = k \times Δ θ$$

If the SEA system 10 generates an output torque (i.e., an action) (Δτ), the load 60 produces a reaction equal in magnitude to the action, but opposite in direction. Such an output torque (Δτ) does not generate a motion of the SEA system 10 or the load 60; rather, the output torque (Δτ) induces a torsional deformation (Δθ) on the elastic element 50 based on following formula:

$$Δτ / k = Δ θ = Δ {θ}_{1} - Δ {θ}_{2}$$

If the value of the output torque (Δτ) cannot be directly measured, the value can be estimated when the stiffness (K) of the elastic element 50 is known and the deformation values (Δθ₁, Δθ₂) are measured by an encoder module 80.

As described above, the elastic element 50 of a SEA system 10 generates a compliant mechanical interface between the motor 20 and the load 60. However, the SEA-load interaction of the traditional SEA system 10 cannot be directly measured; rather, it can be estimated indirectly if the stiffness of the elastic element 50 is known and if the elastic deformation of the elastic element 50 can be measured.

### B. Detailed Description of Various Embodiments

While the disclosure is susceptible to various modifications and alternative constructions, certain illustrative embodiments are shown in the drawings and are described below in detail. The dimensions, angles, and curvatures represented in the introduced above are to be understood as exemplary and are not necessarily shown in proportion. It should be understood, however, there is no intention to limit the disclosure to the specific embodiments disclosed, but on the contrary, the intention is to cover all modifications, alternative constructions, combinations, and equivalents falling within the spirit and scope of the disclosure. In the various figures, similar elements are provided with similar reference numbers. The reference numbers used herein are provided merely for convenience and hence do not define the sphere of protection or the scope of the embodiments.

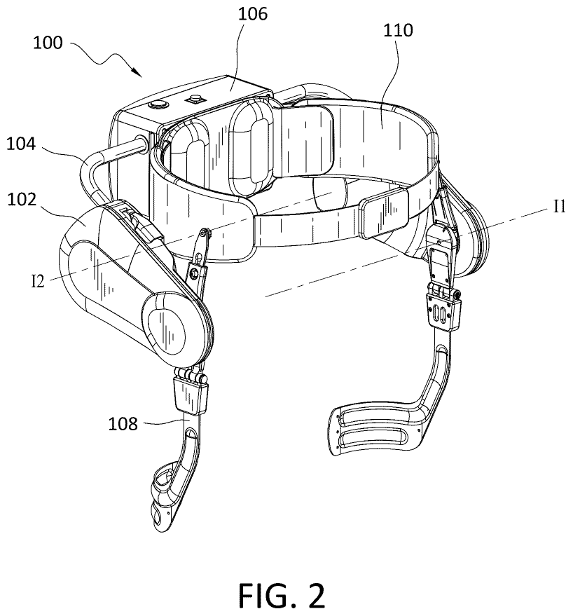

FIG. 2 illustrates an exemplary Active Pelvis Orthosis (APO) 100 for assisting a user with lower-limb mobility. The APO 100 comprises at least one assistive unit 102 to generate assistive force for flexion-extension movement at a first axis I1 corresponding with one or both hips of the user. A housing 103 of the assistive unit 102 contains various components for providing torque about the user's hip flexion-extension joint. The APO 100 features a rear housing or backpack 106 for housing electrical components, such as a power supply and computing unit. The backpack 106 may also retain a width adjustment system and/or locking system for the orientation of the assistive unit 102. The assistive unit 102 is connected to the backpack 106 by a connection element 104. The connection element 104 couples the assistive unit 102 to the backpack 106 and may also be used for retaining electrical cables and/or a power source (e.g., battery). The APO 100 includes a belt 110 and at least one thigh link 108 to interface with a user. The belt 110 provides an attachment point to the user's abdominal and lumbar regions, and the thigh link 108 provides an attachment point to the user's thigh. The thigh link 108 is rotatably attached to the housing 103 by a link attachment 109, and the link attachment 109 is substantially aligned with the first axis I1 to permit flexion and extension of the user's lower limb.

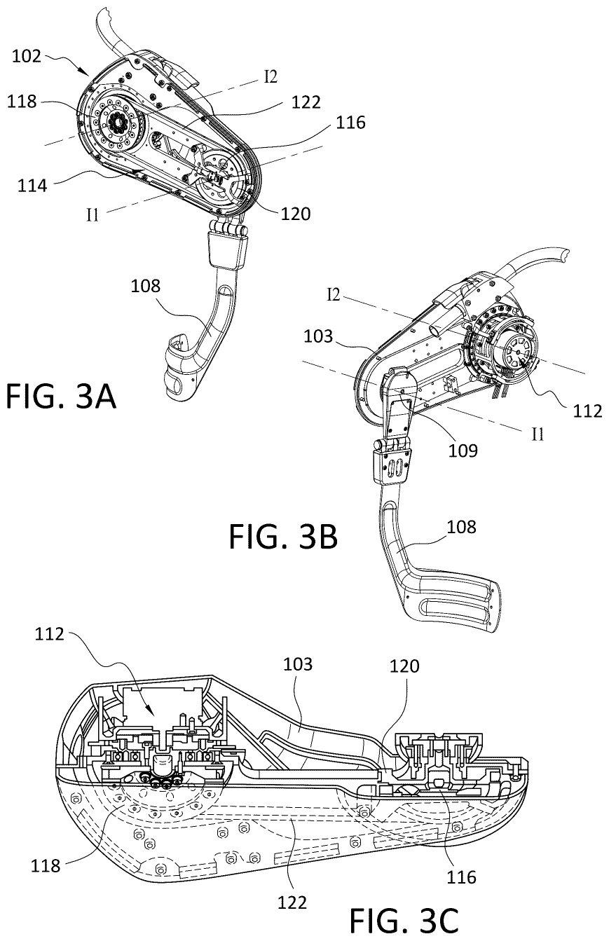

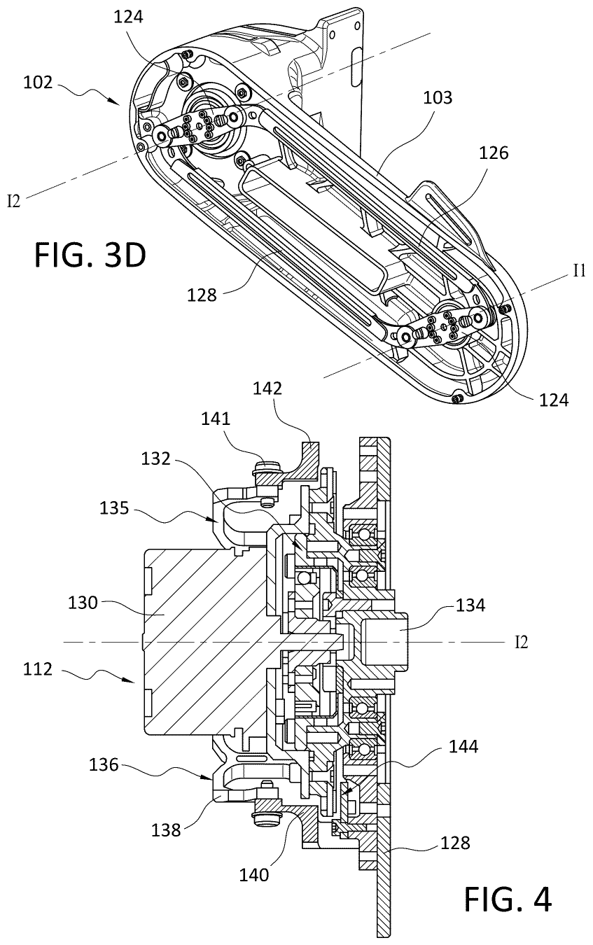

FIGS. 3A-3C show cross-sectional views of the assistive unit 102 in FIG. 2. The assistive unit 102 generates torque for the user's hip flexion-extension motion. The assistive unit 102 comprises an actuator or actuation unit 112 and transmission unit 114 within a housing 103. The assistive unit 102 is positioned on the right side and/or left side of the user's body. In an embodiment, the second axis I2 is the output axis of rotation and ideally aligned with the user's hip flexion-extension axis and parallel to the first axis I1. Through the thigh link 108, the assistive unit 102 transmits assistive torque to the leg of a user. As observed in FIGS. 3A-3B, the assistive unit 102 is developed on first and second axes I1, I2, wherein the first axis corresponds to the location of the actuation unit 112 and the second axis I2 generally corresponds to the user's hip-flexion extension joint. The transmission unit 114 transfers motion and torque between the two axes I1, I2, wherein the first axis I1 corresponds to an output axis of the assistive unit 102 and the second axis I2 corresponds to an input axis of the assistive unit. A joint encoder 116 measures the rotation of the thigh link 108 about the first axis I1 that coincides with the user's thigh orientation. The joint encoder 116 may be magnetic and act as a redundant safety mechanism.

The transmission unit 114 comprises a first timing pulley 118, a second timing pulley 120, and a synchronous timing belt 122. In an embodiment, the transmission unit 114 has a fixed center distance between the timing pulleys 118, 120. In an alternative embodiment, the transmission unit 114 features an adjustable center distance between timing pulleys 118, 120. The transmission unit 114 may also feature a transmission ratio value equal to or different than 1:1. The timing belt 122 may have a polyurethane construction resistant to pollutants and abrasion and feature a carbon fiber tensile cord. The first and second timing pulleys 118, 120 may have a nylon construction for good mechanical properties, fatigue resistance, and weight reduction. In an embodiment, the first timing pulley 118 functions as a driver timing pulley and is concentric with the actuation unit 112 at the second axis I2. The second timing pulley 120 functions as a driven timing pulley and is concentric with the link attachment 109 at the first axis I1. The transmission unit 114 helps preserve the motor axis I1 from the loading actions coming from the interaction between the thigh link 108 and the user's leg. Additionally, the transmission unit 114 allows for placement of the more cumbersome elements near an area of the user's body, namely the lateral part of the gluteus, to avoid a higher lateral encumbrance.

FIG. 3D depicts the assistive unit 102 having a transmission unit 114 comprising cranks 124 and rods 126. The transmission unit 114 can be designed using different means for transferring mechanical power between the two parallel axes I1, I2, such as a four-bar mechanism or a chain drive system. In an alternative embodiment, the assistive unit 102 of the APO 100 may exclude a transmission unit 114 operating about two axes I1, I2 and instead incorporate the actuation unit 112 on the same axis I1 as the thigh link attachment 109. Thus, the disclosed actuation unit 112 may be directly collocated with respect to the user's hip flexion-extension axis, or first axis I1.

FIG. 4 illustrates a cross-sectional view of an exemplary of the disclosed actuation unit 112. The actuation unit 112 is a customized, rotative, electric Series Elastic Actuator powered by a brushless motor 130. The motor 130 transmits rotation and torque at an output shaft 134 of the actuation unit 112 through a gearbox 132. The gearbox 132 acts as a speed reducer and torque amplifier and is based on a harmonic drive.

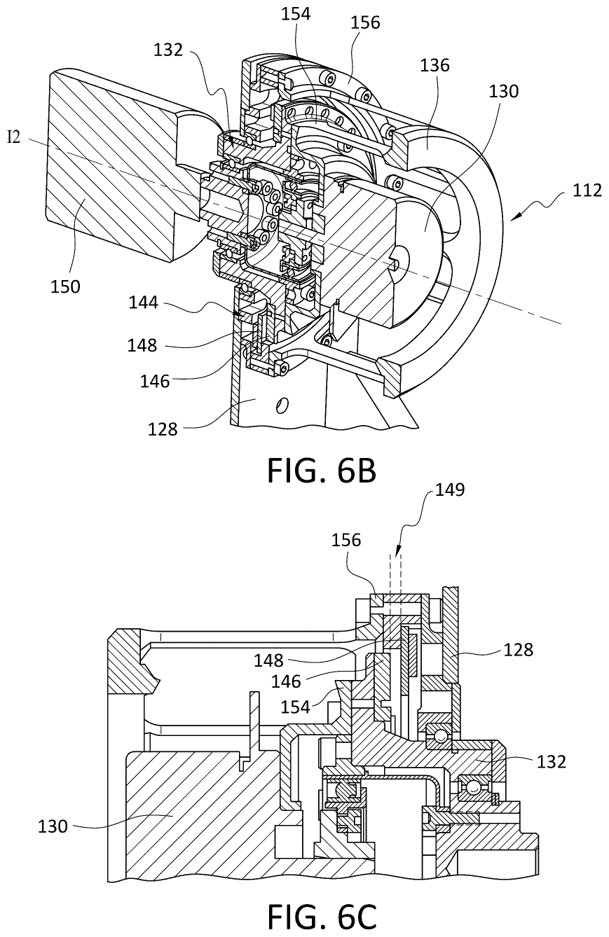

A combination of elastic elements or torsional springs 138, 140, 142 connected by fasteners 141 act together as a unified elastic assembly 135 and connect, in a compliant manner, the motor 130 and the gearbox 132 to a frame 128. The fasteners 141 may be screws, bolts, clips, and/or other rigid connecting elements. The reaction torques generated by the gearbox 132 and the motor 130 induce a deformation of the elastic elements 138, 140, 142, wherein the deformation is read by an encoder module 144. The encoder module 144 comprises an encoder ring 146 connected to an input flange or first flange 154 and an encoder readhead 148 connected to an output flange or second flange 156, which will be described in greater detail below with reference to FIG. 6C. The encoder module 144 computes the torque generated by the actuation unit 112 based on the stiffness values of the elastic elements 138, 140, 142.

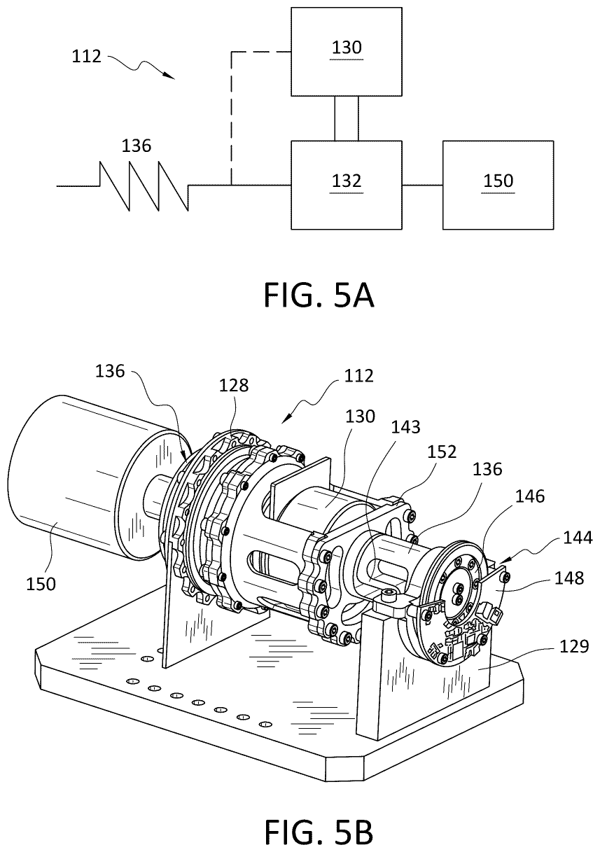

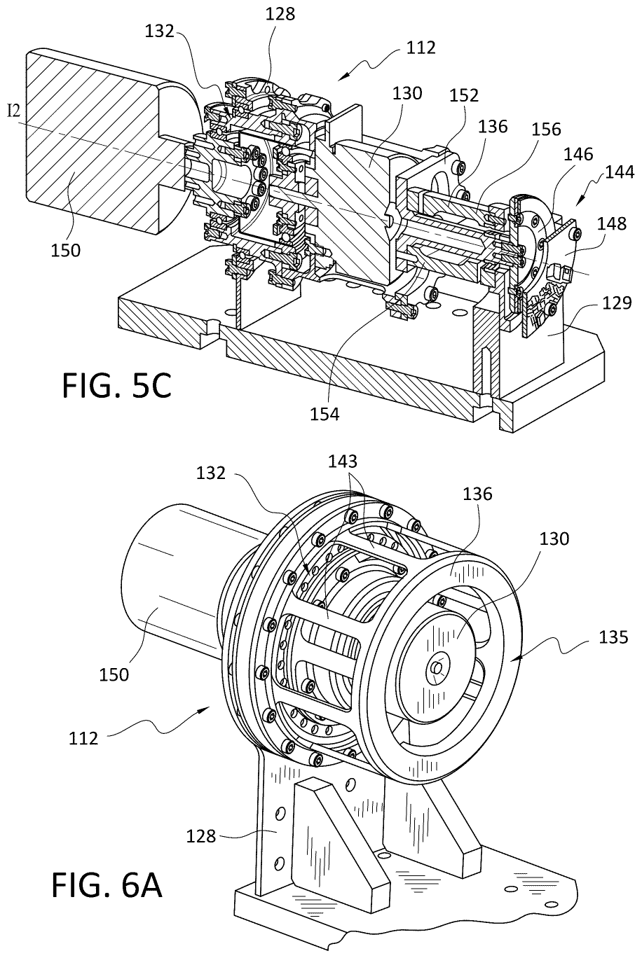

FIG. 5A shows a general architecture of the actuation unit 112 and a monolithic torsional spring 136 with respect to the other elements of the actuation unit 112. Advantageously, the torsional spring 136 is at the beginning end of the actuation unit 112, opposite the load 150, instead of between the gearbox 132 and the load 150. The dashed line connecting the motor 130 to the torsional spring 136 indicates a negligible interaction between the two components because the interaction between the motor 130 and the torsional spring 136 is approximately two orders of magnitude smaller than the interaction between the gearbox 132 and the torsional spring 136.

FIGS. 5B-C illustrate an embodiment of the actuation unit 112. The actuation unit 112 comprises a torsional spring 136 according to WO 2015/001469 A1, the publication being incorporated herein by reference. In an embodiment, the torsional spring 136 is parallelepiped-shaped having linear segments 143 extending parallel to the second axis I2 and provides a compact torsional elastic element, provided with a linear angle/torque characteristic which is also not affected by the direction of rotation, allows avoiding unwanted contact between its parts, has high capacity of interfacing with the elements to which it should be connected, and is capable of attaining a high transmissible torque relative to its weight and overall dimension. The stiffness value of the torsional spring 136 in an embodiment is preferably within 100 Nm/rad to 5,000 Nm/rad, the range of values enabling performance of an accurate and stable torque control of the actuation unit 112. In an exemplary embodiment, the stiffness value of the torsional spring 136 is approximately 200 Nm/rad. The desired stiffness value of the torsional spring 136 depends on several aspects, such as the resolution of the encoder 144 used for reading the deformation of the torsional spring 136.

A fundamental variant for obtaining the desired characteristics of the torsional spring 136 lies in the material or materials used; the most suitable materials are the metals generally used in mechanical constructions. They include steel, aluminium alloys and titanium alloys. Primarily, there may be identified in the Young's modulus of the selected material, the fundamental parameter for obtaining the desired rigidity characteristics of the torsional spring 136. Besides the desired rigidity, the selection of the material to be used directly follows the amount of mechanical load 150 that the torsional spring 136 should be capable of bearing and the degree of dimensional compactness to be obtained. Moreover, the assembly of the actuation unit 112 and torsional spring 136 of the embodiment in FIGS. 5B-C is defined univocally and repeatable.

The actuation unit 112 comprises a first frame 128 and a second frame 129 to rigidly support components of the actuation unit 112 and housing 103 of the assistive unit 102. The torsional spring 136 has a first flange 154 connected to a motor casing 152 and a second flange 156 connected to the second frame 129. The actuation unit 112 further comprises an encoder module 144 having an encoder ring 146 and a readhead 148. The encoder module 144 directly reads the relative rotation of the second flange 156 of the torsional spring 136 about the second axis I2 with respect to the first flange 154, without using frames 128, 129 as angular reference points. The encoder ring 146 is connected to the first flange 154 of the torsional spring 136 and the encoder readhead 148 is connected to the second flange 156 of the torsional spring 136. The motor casing 152 contains a brushless motor 130 that is connected to a gearbox 132. The gearbox 132 extends through the first frame 128 to interface with the load 150. The load 150 depicted in FIGS. 5A-C relates to the mechanical system or transmission unit 114 that is being driven by the actuation unit 112. The embodiment of the actuation unit 112 in FIGS. 5B-C reduces weight and encumbrance compared to the traditional SEA system 10 depicted in FIG. 1B by having a single encoder module 144 and two frames 128, 129.

FIGS. 6A-C illustrate an alternative embodiment of the actuation unit 112. As depicted, the monolithic torsional spring 136 is at the beginning end of the actuation unit 112, opposite the load 150, instead of between the gearbox 132 and the load 150. The torsional spring 136 has an output flange or second flange 156 directly connected to a single frontal frame 128 of the actuation unit 112. The input flange or first flange 154 is directly connected to the gearbox 132. The torsional spring 136 circumferentially surrounds the motor 130 about the second axis I2 and comprises linear segments 143 that extend parallel to the second axis I2. The embodiment of the actuation unit 112 in FIGS. 6A-C further reduces weight and encumbrance compared to the traditional SEA system 10 depicted in FIG. 1B by having a single frame 128. As depicted in FIG. 6C, the torsional (Δθ) of the spring is measured by an encoder module 144 that has its ring 146 rigidly connected to the first flange 154 while the readhead 148 is rigidly connected to the output flange of the spring. By datasheet, the ring 146 and readhead 148 work properly if their axial distance or gap 149 is within a defined range of values. In an embodiment, the gap 249 is between 0.05 mm to 0.35 mm.

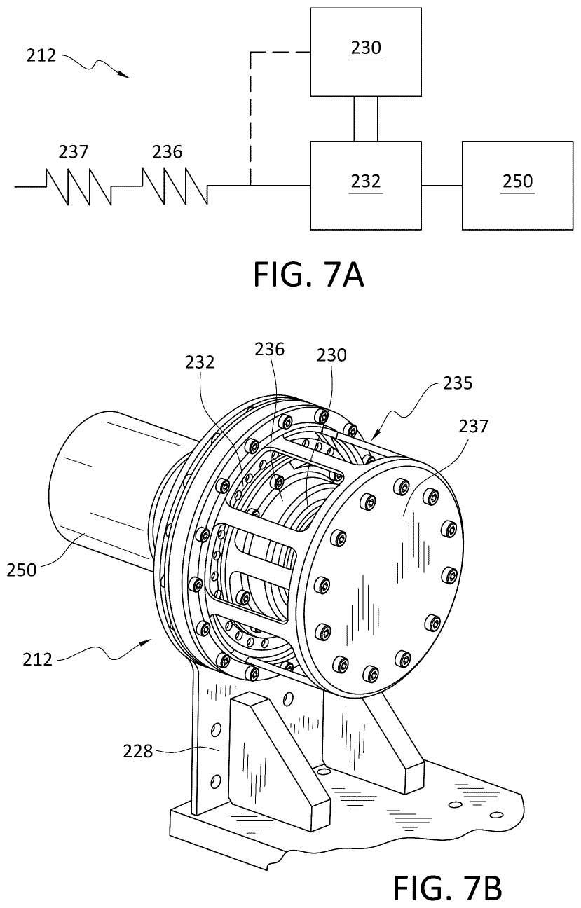

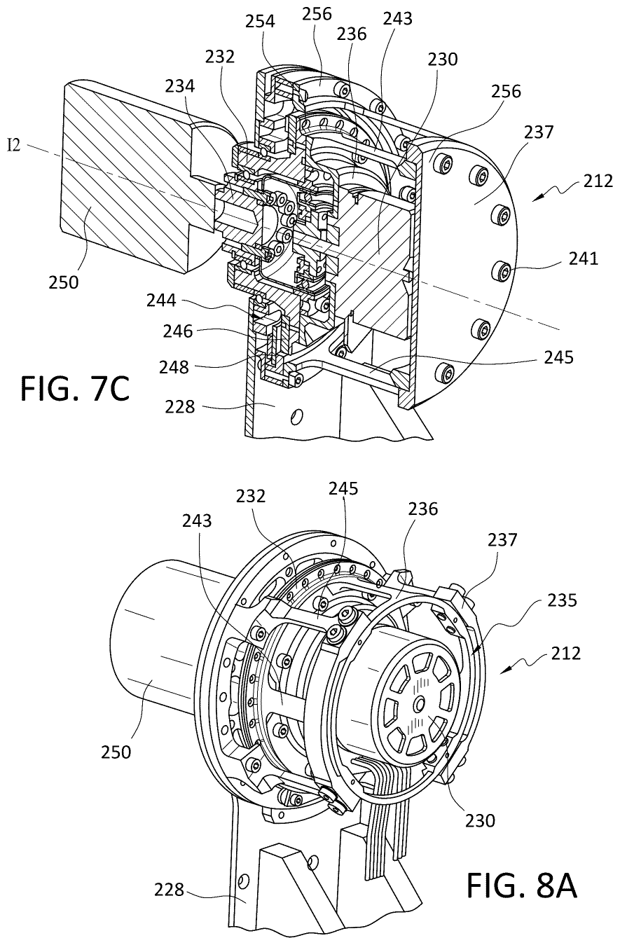

FIG. 7A shows a general architecture of an actuation unit 212 having a first torsional spring 236 and a second torsional spring 237. Advantageously, the first and second torsional springs 236, 237 are connected in series and at the beginning end of the actuation unit 212, opposite the load 250 and not between the gearbox 232 and the load 250. The dashed line connecting the motor 230 to the first and second torsional springs 236, 237 indicates a negligible interaction between the components because the interaction between the motor 230 and the first and second torsional springs 236, 237 is approximately two orders of magnitude smaller than the interaction between the gearbox 232 and the first and second torsional springs 236, 237.

FIGS. 7B-C illustrate an embodiment of the actuation unit 212. The actuation unit 212 comprises first and second torsional springs 236, 237, wherein the first and second torsional springs 236, 237 form a unified elastic assembly 235. The equivalent stiffness values of the unified elastic assembly 235 is preferably within 100 Nm/rad to 5,000 Nm/rad, the range of values enabling performance of an accurate and stable torque control of the actuation unit 212. In an exemplary embodiment, the stiffness value of the elastic assembly 235 is approximately 5,000 Nm/rad. The desired stiffness value of the elastic assembly 235 depends on several aspects, such as the resolution of the encoder module 244 used for reading the deformation of the torsional springs 236, 237. Additionally, the material or materials used in mechanical the construction of the first and second torsional springs 236, 237 include steel, aluminium alloys and titanium alloys.

The actuation unit 212 comprises a frame 228 to rigidly support components of the actuation unit 212. The first torsional spring 136 has a first flange 254 connected to the gearbox 232 and a connecting flange 256 interfacing with the second torsional spring 237. The second torsional spring 237 comprises a second flange 256 connected to the frame 228. The first and second torsional springs 236, 237 are connected along the axial dimension, parallel to the second axis I2 of the actuation unit 112. The actuation unit 212 further comprises an encoder module 244 having an encoder ring 246 and a readhead 248. The encoder module 244 directly reads the relative rotation of the second flange 256 of the second torsional spring 237 about the second axis I2 with respect to the first flange 254 of the first torsional spring 236, without using the frames 228 as an angular reference point. The brushless motor 230, encompassed by the torsional springs 236, 237, is connected to a gearbox 232. The gearbox 232 extends through the frame 228 to interface with the load 250 and comprises an output shaft 234 to engage with the load 250. The load 250 depicted in FIGS. 7A-C relates to a mechanical system or transmission unit 114 that is being driven by the actuation unit 212. The embodiment of the actuation unit 212 in FIGS. 7B-C reduces manufacturing costs by having two distinct torsional springs 236, 237.

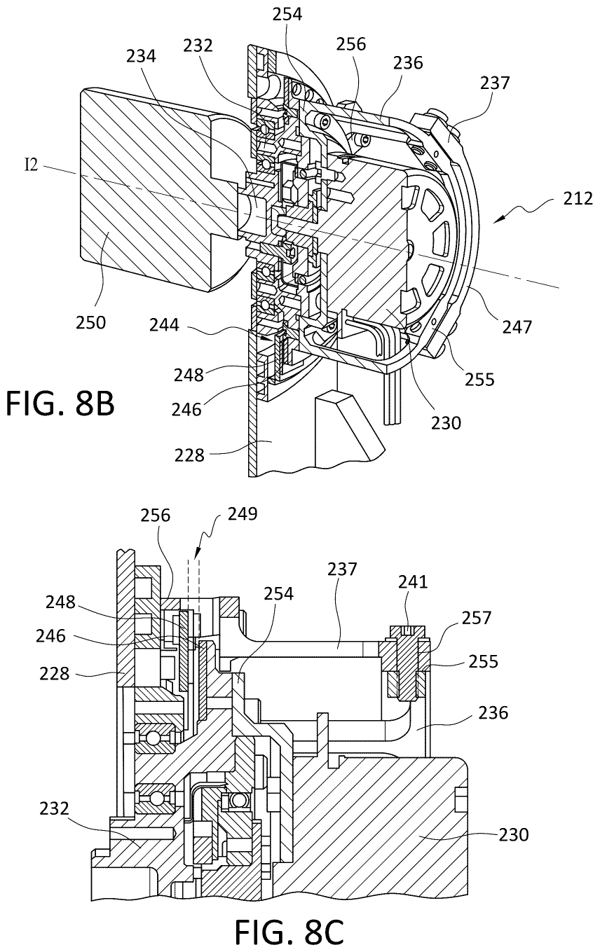

FIGS. 8A-C illustrate an alternative embodiment of the actuation unit 212. As depicted, the torsional springs 236, 237 are in series and integrated at the beginning end of the actuation unit 212, opposite the load 250, instead of between the gearbox 232 and the load 250. The first flange 254 of the first torsional spring 236 is connected to the gearbox 232. The second torsional spring 236 has a second flange 256 connected to the frame 228 of the actuation unit 212. The first and second torsional springs 236, 237 are oriented along the radial dimension of the actuation unit 212 to interrupt a chain of axial relative placement of the different components. The first torsional spring 236 has linear segments 243 extending parallel to the second axis I2. The second torsional spring 237 has linear segments 245 extending parallel to the second axis I2 having a greater radial distance to the second axis I2 than the first torsional spring 236. The second torsional spring 237 also has at least two opposing arcuate segments 247 that partially and radially extend about the first torsional spring 236.

The first torsional spring 236 and second torsional spring 237 are connected by fasteners 241 that are radially oriented about the second axis I2 at connecting flanges 255. The first and second torsional springs 236, 237 form a unified elastic assembly 235. The equivalent stiffness values of the unified elastic assembly 235 is preferably within 100 Nm/rad to 5,000 Nm/rad, the range of values enabling performance of an accurate and stable torque control of the actuation unit 212. This specifically allows for the assembly of the actuation unit 212 and torsional springs 236, 237 depicted in FIGS. 8A-C is defined univocally and repeatable. In an exemplary embodiment, the stiffness value of the elastic assembly 235 is approximately 2,000 Nm/rad.

FIG. 8C highlights a chain of mating parts between the torsional springs 236, 237, each having a specific dimensional tolerance, that presents a clearance given by apertures 257 in the second torsional spring 237 for accepting fasteners 241 to connect the first and second torsional springs 236, 237. The first torsional spring 236 circumferentially surrounds the motor 230 about the second axis I2 and comprises linear segments 243 that extend parallel to the second axis I2. The embodiment of the actuation unit 212 in FIGS. 8A-C further reduces weight and encumbrance by having a single frame 228. The manufacturing cost, specifically for the first torsional spring 236, are also reduced.

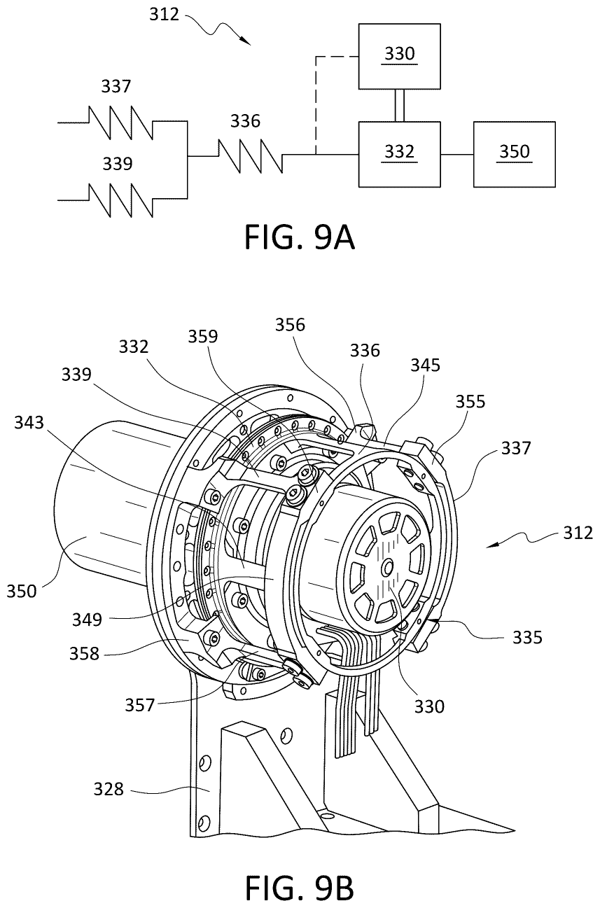

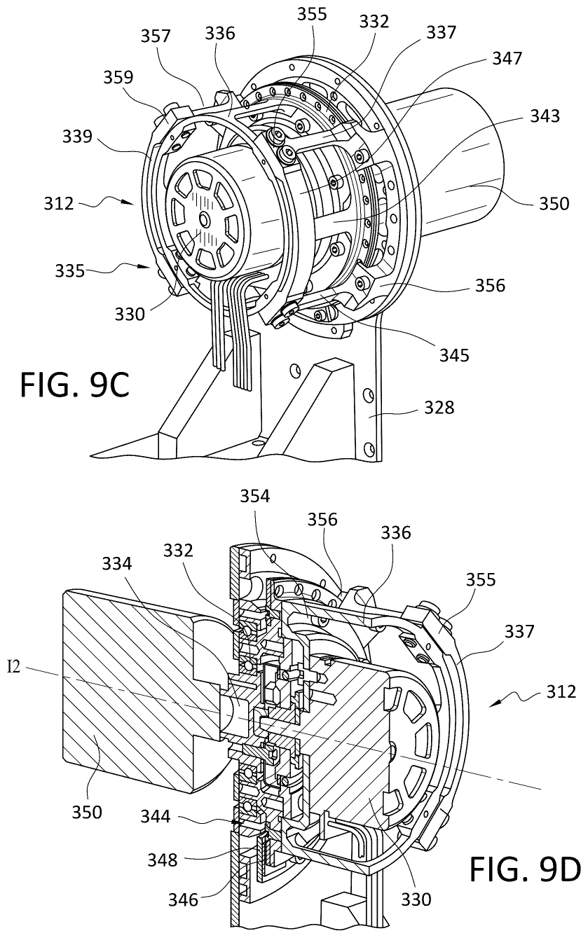

FIG. 9A shows a general architecture of an actuation unit 312 having a first torsional spring 336 connected in series with parallel second and third torsional springs 337, 339. It is to be understood that actuation units 212 and 312 are various embodiments of actuation unit 112. Advantageously, the first torsional spring 336 and parallel second and third torsional springs 337, 339 are connected in series and at the beginning end of the actuation unit 312, opposite the load 350 and not between the gearbox 332 and the load 350. The dashed line connecting the motor 330 to the torsional springs 336, 337, 339 indicates a negligible interaction between the components because the interaction between the motor 330 and the torsional springs 336, 337, 339 is approximately two orders of magnitude smaller than the interaction between the gearbox 332 and the torsional springs 336, 337, 339.

FIGS. 9B-D illustrate an embodiment of the actuation unit 312. The actuation unit 312 comprises first, second, and third torsional springs 336, 337, 339, wherein the torsional springs 336, 337, 339 form a unified elastic assembly 335. The equivalent stiffness values of the unified elastic assembly 335 is preferably within 100 Nm/rad to 5,000 Nm/rad, the range of values enabling performance of an accurate and stable torque control of the actuation unit 312. In an exemplary embodiment, the stiffness value of the elastic assembly 335 is approximately 2,000 Nm/rad. The desired stiffness value of the elastic assembly 335 depends on several aspects, such as the resolution of the encoder module 344 used for reading the deformation of the torsional springs 336, 337. Additionally, the material or materials used in mechanical the construction of the torsional springs 336, 337, 339 include steel, aluminium alloys and titanium alloys.

The actuation unit 312 comprises a frame 328 to rigidly support components of the actuation unit 312. The first torsional spring 336 has a first flange 354 connected to the gearbox 332 and connecting flanges 355, 359 interfacing with the second and third torsional springs 337, 339. The second torsional spring 337 comprises a second flange 356 connected to the frame 328 and interfaces with the first torsional spring 336 at one or more connecting flanges 355. The first torsional spring 336 and second torsional spring 337 are connected by fasteners 341 that are radially oriented about the second axis I2 at one or more connecting flanges 355. The third torsional spring 339 comprises a third flange 358 connected to the frame 328 and interfaces with the first torsional spring 336 at one or more connecting flanges 359. The first torsional spring 336 and the third torsional spring 339 are connected by fasteners 341 that are radially oriented about the second axis I2 at one or more connecting flanges 359. The second torsional spring 337 and third torsional spring 339 form at least two opposing arcuate segments 347, 349 that partially and circumferentially extend about the first torsional spring 336.

As depicted, the torsional springs 336, 337, 339 are at the beginning end of the actuation unit 312, opposite the load 350, instead of between the gearbox 332 and the load 350. The first torsional spring 336 has linear segments 343 extending parallel to the second axis I2. The second torsional spring 337 has linear segments 345 extending parallel to the second axis I2 having a greater radial distance to the second axis I2 than the first torsional spring 236. The third torsional spring 339 also has linear segments 357 extending parallel to the second axis I2 having a greater radial distance to the second axis I2 than the first torsional spring 336.

The actuation unit 312 further comprises an encoder module 344 having an encoder ring 346 and a readhead 348. The encoder module 344 simultaneously reads the deformation of flanges 356, 358 respectively of the second and third torsional springs 236, 237, wherein the flanges 356, 358 flanges are rigidly connected with the frame 328. The brushless motor 330, encompassed by the torsional springs 336, 337, 339, is connected to a gearbox 332. The gearbox 332 extends through the frame 328 to interface with the load 350 and comprises an output shaft 334 to engage with the load 350. The load 350 depicted in FIGS. 9A-D relates to a mechanical system or transmission unit 114 that is being driven by the actuation unit 312. The embodiment of the actuation unit 312 in FIGS. 9B-C reduces manufacturing costs by having two distinct torsional springs 236, 237. Moreover, the assembly of the actuation unit 312 and torsional spring 336, 337, 339 of the embodiment in FIGS. 5B-C is defined univocally and repeatable.

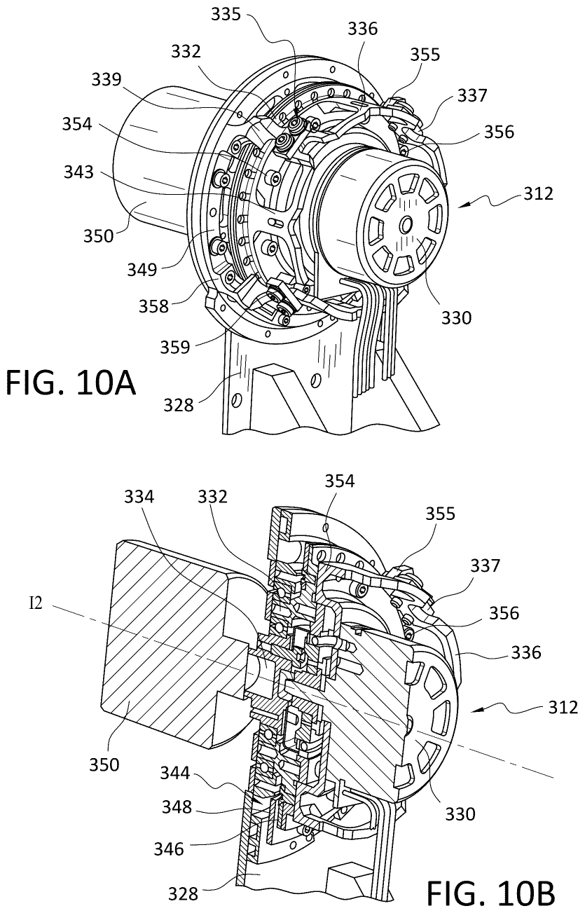

FIGS. 10A-B illustrate an alternative embodiment of the actuation unit 312. The torsional springs 336, 337, 339 are at the beginning end of the actuation unit 312, opposite the load 350 and not between the gearbox 332 and the load 350. Without significant variations in stiffness value, a reduction in the axial direction of the inner or first torsional spring 336 is achieved by spreading its axial length such that multiple linear segments 343 of the first torsional spring 336 do not extend past the motor 330 along the second axis I2. This embodiment of the actuation unit 312 preserved the initial length of the deformable part of the torsional spring 336 and reduces the total axial encumbrance.

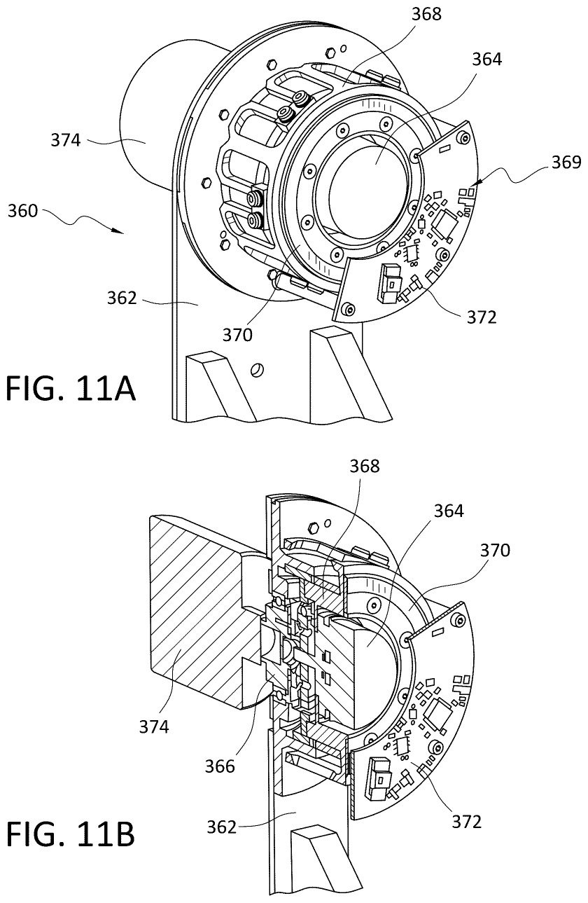

FIGS. 11A and 11B illustrate yet another embodiment of an actuation unit 360. The actuation unit 360 is provided with a frame 362, a motor 364, a gearbox 366, a torsional spring 368, and a rotary encoder 369 including an encoder ring 370 and a readhead 372. A hypothetical load 374 is connected to the actuation unit 360. According to this embodiment, the rotary encoder 369 is placed on a back or rear of the assembly, the gearbox 366 is simplified, and there is one torsional spring.

According to the arrangement of the torsional spring 368, the basement and the deformable parts of the spring are flipped by 180° degrees with respect to the plane of the frame 362. The rotary encoder module 369 is positioned on the rear side of the assembly, utilizing the spring's 368 base as the mounting surface. This arrangement, over the embodiment of FIGS. 10A-10B, enhances the assembly and disassembly procedure of the rotary encoder module; in particular, the mounting procedure to guarantee the required axial distance among the encoder ring and the redhead encoder is simplified.

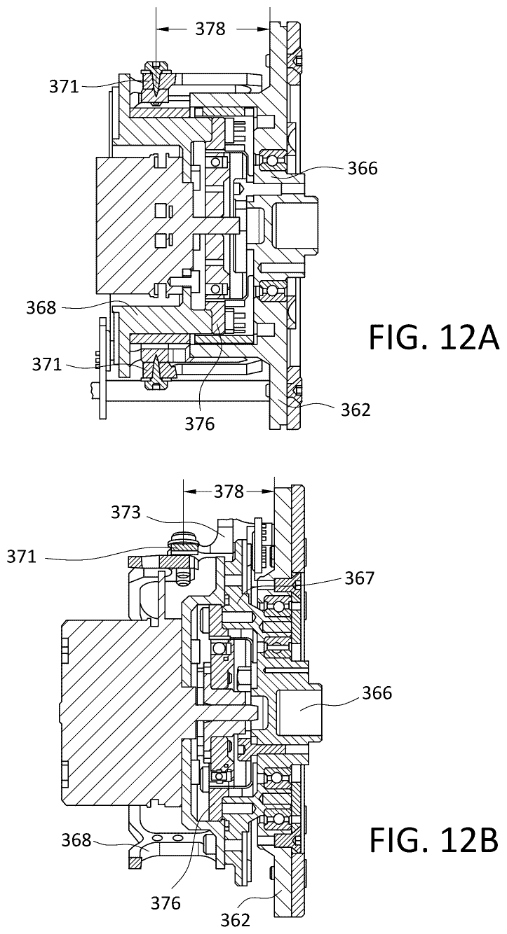

As shown in FIGS. 12A-12B, the arrangement of the gearbox of the embodiment of FIGS. 11A-11B represented in FIG. 12A, has one fewer component with respect to the embodiment of FIGS. 10A-10B, as shown in FIG. 12B. In particular, the component labeled 367 in FIG. 12B is not present in FIG. 12A. This is possible due to (i) the mounting of the rotary encoder module on the back side of the assembly, and (ii) the mounting of the circular spline 376 of the harmonic drive (HD) on the spring (i.e., 368 in FIG. 12A; 368, 373 in FIG. 12B) instead of on component 367. As a consequence, the assembly and disassembly procedure of the SEA is improved as well as its manufacturing cost is reduced.

As shown in FIG. 12A, there is one less spring 368 compared to the two springs 368, 373 observed in FIG. 12B, i.e., spring 373 is not present in FIG. 12A. This is made possible through the redesigned spring 368, specifically by increasing the axial distance (refer to distance 378) between the springs connecting flange 371 and the main plane of frame 362. This adjustment allowed the direct connection of the frame 362 to spring 368 with minimal impact on its stiffness to the design in FIG. 12B.

The spring diagram of FIG. 9A applies to the embodiment of FIGS. 11A-12A.

From the foregoing discussion on the embodiment of FIGS. 11A-12A, based on APO requirements, all the design solutions adopted in the assembly presented in this section bring to satisfy the following aspects for the APO and the actuation unit thereof, and especially for its elastic element: (i) the stiffness value of the spring is within a range of values that enable to perform an accurate and stable torque control of the system; (2) the elastic element has been design based on fatigue criteria; (iii) the assembly procedure of the SEA and of its elastic element is defined univocally; (iv) the weight and the radial and axial encumbrance of the SEA and of its elastic element are limited; and (v) the manufacturing cost of the elastic elements can be considered low for mass production.

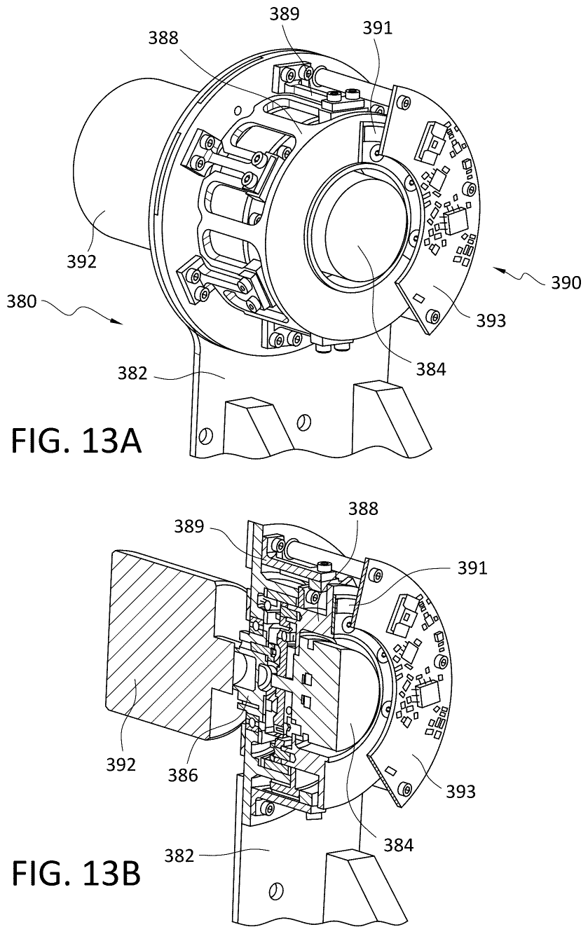

FIGS. 13A and 13B illustrate yet another embodiment of an actuation unit 380. The actuation unit 380 is provided with a frame 382, a motor 384, a gearbox 386, two torsional springs 388, 389, and a rotary encoder 390 including an encoder ring 391 and a readhead 393. A hypothetical load 392 is connected to the actuation unit 380.

The actuation unit 380 is arranged to achieve a weight and cost reduction. Accordingly, to read the torsional deformation of the spring, only a small sector of the encoder ring is needed. To achieve a reduction of the manufacturing cost for the frame 382, the second torsional spring 389 is arranged to connect to the frame 382 and the first torsional spring 388, thereby compensating at the same time their relative position in the radial and axial directions. Consequently, the second torsional spring 389 helps to reduce the required tolerances needed for the assembly of the frame 382 and the first torsional spring 388.

The spring diagram of FIG. 9A applies to the embodiment of FIGS. 11A-12A. Moreover, the same design criteria as mentioned above, such as in connection with the embodiment of FIGS. 11A-11B, are satisfied.

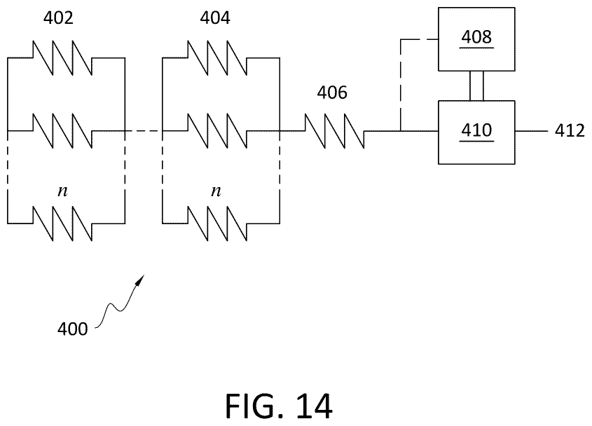

FIG. 14 illustrates another embodiment of an elastic element 400. The elastic element is composed of multiple deformable parts, including a first series and parallel elasticity 402, a second series and parallel elasticity 404, and a series elasticity 406. The line connecting the motor 408 to the series elasticity 406 is dashed because, in the design of the actuation unit, their interaction can be considered two orders of magnitude smaller respect to the one between the gear train 410 and the series elasticity 406, which in turn transmits to or of the load 412.

Furthermore, the features and/or components of one embodiment, example, or figure discussed, shown, or suggested hereinabove may be combined with features and/or components of other embodiments, examples, or figures discussed, shown, or suggested herein to provide embodiments, examples, or implementation variations that are not explicitly verbally or visually described or shown herein.

One skilled in the art will realize that the disclosed elastic element assembly may be composed of multiple deformable parts in parallel and series among each other to develop further embodiments. These and other alternatives will readily occur to the skilled artisan in view of the present disclosure and are encompassed within the subject matter of the present disclosure.

It is to be understood that even though numerous characteristics and advantages of various embodiments of the present disclosure have been set forth in the foregoing description, together with details of the structure and function of various embodiments thereof, this detailed description is illustrative only, and changes may be made in detail, especially in matters of structure and arrangements of parts within the principles of the present disclosure to the full extent indicated by the broad general meaning of the terms in which the appended claims are expressed.

1.-20. (canceled)

21. An actuator apparatus comprising:
a gearbox based on a harmonic drive;
a motor for transmitting rotation and torque at an output shaft through the gearbox to support a mechanical load; and
a first torsional spring connecting the motor and the gearbox to a frame.

22. The actuator apparatus of claim 21, wherein the first torsional spring, motor, and the gearbox are aligned along an output axis of rotation, the torsional spring and the load being on opposing ends of the actuator apparatus, and the motor and the gearbox being in between the torsional spring and the load.

23. The actuator apparatus of claim 22, further comprising an encoder module.

24. The actuator apparatus of claim 23, wherein the encoder module directly reads relative rotation (Δθ) of an output flange of the first torsional spring about an output axis of rotation.

25. The actuator apparatus of claim 21, wherein interaction between the motor and the first torsional spring is two orders of magnitude smaller than the interaction between the gearbox and the first torsional spring.

26. An actuator apparatus comprising:
a gearbox based on a harmonic drive;
a motor for transmitting rotation and torque through the gearbox to support a mechanical load;
a first torsional spring and a second torsional spring connected in series to connect the motor and the gearbox to a frame; and
an encoder module.

27. The actuator apparatus of claim 26, wherein the second torsional spring has at least two opposing arcuate segments that partially and circumferentially extend about the first torsional spring.

28. The actuator apparatus of claim 26, wherein the first torsional spring, the second torsional spring, the motor, and the gearbox are aligned along an output axis of rotation.

29. The actuator apparatus of claim 26, wherein the first and second torsional springs and load are on opposing ends of the actuator apparatus, and the motor and the gearbox are in between the torsional spring and the load.

30. The actuator apparatus of claim 26, wherein the first torsional spring and the second torsional spring are connected through fasteners oriented along an axial dimension of the actuator apparatus.

31. The actuator apparatus of claim 26, wherein the first torsional spring has linear segments extending parallel to an output axis of rotation.

32. The actuator apparatus of claim 26, wherein the second torsional spring has linear segments extending parallel to an output axis of rotation.

33. The actuator apparatus of claim 26, wherein the second torsional spring has a greater radial distance to an output axis of rotation than the first torsional spring.

34. The actuator apparatus of claim 26, wherein the first torsional spring and the second torsional spring are connected through fasteners oriented along a radial dimension of the actuator apparatus.

35. An actuator apparatus comprising:
a gearbox based on a harmonic drive;
a motor for transmitting rotation and torque through the gearbox to support a mechanical load; and
a first torsional spring connected in series with parallel second and third torsional springs and connected in series with the motor and the gearbox to a frame.

36. The actuator apparatus of claim 35, further comprising an encoder module.

37. The actuator apparatus of claim 35, wherein the first, second, and third torsional springs and load are on opposing ends of the actuator apparatus, and the motor and gearbox are in between the torsional springs and the load.

38. The actuator apparatus of claim 35, wherein the second torsional spring and the third torsional spring form at least two opposing arcuate segments that partially and circumferentially extend about the first torsional spring.

39. The actuator apparatus of claim 35, wherein the first torsional spring and the second torsional spring are connected through fasteners oriented along a radial dimension of the actuator apparatus.

40. The actuator apparatus of claim 35, wherein the first torsional spring comprises linear segments extending parallel to an output axis of rotation about the gearbox, the motor extending parallel to an output axis of rotation away from the load and beyond the linear segments of the first torsional spring.
